(19) United States
(12) Patent Application Publication
(10) Pub. No.: US 2024/0394644 A1
(43) Pub. Date: Nov. 28, 2024

(54) DYNAMIC SYSTEM AND METHOD FOR DELIVERY TO A MOVING CUSTOMER FOR A DELIVERY

(71) Applicant: Storyville Coffee Company LLC, Bainbridge Island, WA (US)

(72) Inventor: Jonathan D. Phelps, Winter Park, FL (US)

(21) Appl. No.: 18/675,606

(22) Filed: May 28, 2024

Related U.S. Application Data
(60) Provisional application No. 63/469,259, filed on May 26, 2023.
(60) Provisional application No. 63/533,441, filed on Aug. 18, 2023.

(51) Int. Cl. G06Q 10/083; H04W 4/02; H04W 4/021; H04W 68/00

(52) U.S. Cl. CPC G06Q 10/083; H04W 4/021; H04W 4/025; H04W 68/005

(57) ABSTRACT

A server or shop device has network connectivity and a processor. The server or shop device processes an order for one or more goods to be delivered. The server or shop device communicates with a customer device that has geolocation capability. The server or shop device identifies a geolocation of the customer, when the order is ready for delivery, using communication with the customer device. The server or shop device indicates the so identified geolocation, for the delivery.

### CROSS-REFERENCE

This application claims benefit of priority from U.S. Provisional Application No. 63/533,441 titled SYSTEM AND METHOD FOR DYNAMICALLY LOCATING A MOVING CUSTOMER FOR A DELIVERY, filed Aug. 18, 2023, and benefit of priority from U.S. Provisional Application No. 63/469,259 titled SYSTEM AND METHOD FOR DYNAMICALLY LOCATING A MOVING CUSTOMER FOR A DELIVERY, filed May 26, 2023, both of which are hereby incorporated by reference.

### INCORPORATED BY REFERENCE

The disclosures of U.S. Provisional Patent Application No. 63/533,441 titled SYSTEM AND METHOD FOR DYNAMICALLY LOCATING A MOVING CUSTOMER FOR A DELIVERY, filed Aug. 18, 2023, and U.S. Provisional Application No. 63/469,259 titled SYSTEM AND METHOD FOR DYNAMICALLY LOCATING A MOVING CUSTOMER FOR A DELIVERY, are specifically incorporated by reference herein as if set forth in their entirety.

### TECHNICAL FIELD

This application is directed to technological systems and methods for identifying a current location of a potentially moving person to deliver goods and/or services to the current location of the moving person.

### BACKGROUND

Generally, order deliveries are made at a customer's location (e.g., a home or business address) or a particular business location where customers present at that location are notified when their order is ready to be picked up. Such notifications can be made at restaurants, for example, via paging devices issued by the restaurant's staff, via messages sent to a mobile phone number entered by the customer, or simply by calling out the customer's name. Such notification processes are fine for their intended use in a relatively restricted location where the customer is intended to wait and then actively respond when notified, but do not typically allow the customer to continue their desired activities when in other locations. This makes such notification processes inconvenient in some shopping environments. Thus, the manner in which orders are delivered, particularly in large retail environments, lacks efficiency. Accordingly, a system and method are needed that allows for the direct delivery of a good or product to a customer as they move through the retail environment.

### SUMMARY

To improve the state of the art, disclosed herein is a system for delivering a selected good or product to a person or customer that is randomly moving through a delivery envelope, and methods of operation and use thereof, utilizing novel functionalities. Other aspects and advantages of the embodiments will become apparent from the following detailed description taken in conjunction with the accompanying drawings which illustrate, by way of example, the principles of the described embodiments.

In embodiments, a processor-based method for dynamically locating a moving customer in a delivery envelope for a delivery of a good or product to that customer at their current location. The method includes processing, on a server and/or a shop device, an order for one or more goods to be delivered. The method can include continually identifying, using communication with a customer device having geolocation capability, a current location of the customer within the delivery envelope, when the order is ready for the delivery. The method can further includes delivering the order, based on the so identified location of the customer at the time of delivery.

In another embodiment is a system for dynamically locating a moving customer in a delivery envelope for a delivery of a good or product to that customer at their current location. The system includes a server or a shop device, having network connectivity and a processor. The system includes the processor of the server or shop device to perform processing an order for one or more goods to be delivered, communicating with a customer device having geolocation capability, identifying, using communication with the customer device, a current location of the customer within the delivery envelope, when the order is ready for the delivery and indicating for the delivery, the identified current location of the customer.

One embodiment is a tangible, non-transitory, computer-readable media having instructions thereupon which, when executed by a processor, cause the processor to perform a method. The method includes processing, on a server or a shop device, an order for one or more goods to be delivered. The method includes continually identifying, using communication with a customer device having geolocation capability, a current location of the customer within the delivery envelope, when the order is ready for the delivery. In aspects, the method can include indicating the so identified current location of the customer for delivering the order.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale.

FIG. 1 illustrates one embodiment of a retail environment with an indicated customer location;

FIGS. 2A-2C illustrate embodiments of environments where a server communicates with a customer device and a shop device to provide order fulfillment and delivery within the environment of FIG. 1;

FIG. 3 is a flow chart illustrating one embodiment of a process that can be executed within the environment of FIG. 2A;

FIGS. 4-9 illustrate various embodiments of the retail environment of FIG. 1;

FIGS. 10 and 11 are sequence diagrams illustrating embodiments of processes that can be executed within the environment of FIG. 2A;

FIG. 12 illustrates one embodiment of a portion of the retail environment of FIG. 1;

FIG. 13 is a flow chart illustrating one embodiment of a process that can be executed within the environment of FIG. 2A;

FIG. 14 is a sequence diagram illustrating one embodiment of a process that can be executed within the environment of FIG. 2A;

FIG. 15 illustrates one embodiment of a screen of the customer device of FIG. 2A that can be produced during the process of FIG. 14;

FIG. 16 illustrates one embodiment of a screen of the shop device of FIG. 2A showing an order fulfillment and delivery application;

FIG. 17 illustrates one embodiment of a control structure that can be provided using the server and/or shop device of FIG. 2A;

FIGS. 18A and 18B illustrate embodiments of an item with a coupled display module;

FIGS. 19 and 20 illustrate embodiments of environments where a shop application (FIG. 19) and a customer application (FIG. 20) communicate with a display module;

FIG. 21 is a sequence diagram illustrating one embodiment of a process that can be executed within the environments of FIGS. 19 and 20;

FIG. 22 illustrates one embodiment of the retail environment of FIG. 1;

FIGS. 23 and 24 illustrate embodiments of environments where a shop application (FIG. 19) and a customer application (FIG. 20) communicate with a display module via a server;

FIG. 25 is a sequence diagram illustrating one embodiment of a process that can be executed within the environments of FIGS. 23 and 24;

FIG. 26 illustrates one embodiment of an environment where a customer application communicates with a shop application that in turn communicates with a display module;

FIG. 27 is a sequence diagram illustrating one embodiment of a process that can be executed within the environment of FIG. 26; and

FIG. 28 is a simplified diagram of one embodiment of a computer system that can be used in embodiments of the present disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a good” can include two or more such goods unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Generally, because the conventional order pick up processes are inconvenient in typical shopping environments, it is desirable to be able to deliver a selected good or product to a customer directly to the customer at their current location within the shopping environment. The direct delivery of the selected good to the customer allows the customer to continue to move throughout the retail environment without having to delay or make an additional stop at a pickup location, which increases customer satisfaction.

For example, the customer can be at a retail or store location and can desire delivery of a good or product from the store and/or from an in-store establishment, such as, for example, a coffee shop. For purposes of example, an exemplary in-store establishment is a coffee shop that sells drinks, pastries, and the like. However, it is understood that the store or in-store establishment can be any type of retail establishment having a retail environment with a delivery envelope (which delivery envelope can include interior and exterior portions of the retail establishment, e.g., indoor/exterior shopping areas, sitting areas for the retail establishment, parking areas of the retail establishment, and the like), and can provide deliverable goods or products, e.g., the exemplary drinks, pastries from the exemplary coffee shop. In some embodiments, the store and/or in-store establishment can provide services such as, for example and without limitation, repair or cleaning services on the customer's clothing, which can be performed while the customer continues with their shopping.

While the customer can go to the coffee shop, place their order, wait for their order, pick up their order (possibly when notified using one of the previous notification processes), and then continue shopping, this is far from convenient for the customer in terms of time and in terms of a retail experience. It can also be undesirable for the customer to respond when notified that their order is ready to be picked up, since personally responding not only interrupts their shopping, but also requires that they return to the coffee shop. This can be particularly inconvenient in larger stores having an extensive footprint due to the possible distance of the customer from the coffee shop, if the customer has physical disabilities that make traversing the store more difficult, and/or if the customer is managing children or pets.

Accordingly, the coffee shop or other business (whether in-store or external) can desire to deliver the purchased goods directly to the customer. However, in order to do this, the coffee shop needs to identify the customer's current location. While not a requirement, it can be desirable for the customer's location to be obtained without issuing a shop owned device to the client (e.g., a paging device or a beacon device). Requiring such a device means the customer would need to stop by the shop to pick up the device, and the customer would then be responsible for the device until the delivery is received and the device can be retrieved by the delivery personnel. Accordingly, in embodiments, it can be desirable to identify the customer's location using the location of the customer's mobile device (e.g., a smart phone) so the order can be delivered to the location of the customer's mobile device. In addition, as the customer's location can change while the order is being fulfilled and delivered, it can be desirable to obtain updated geolocation information of the customer to account for such movement.

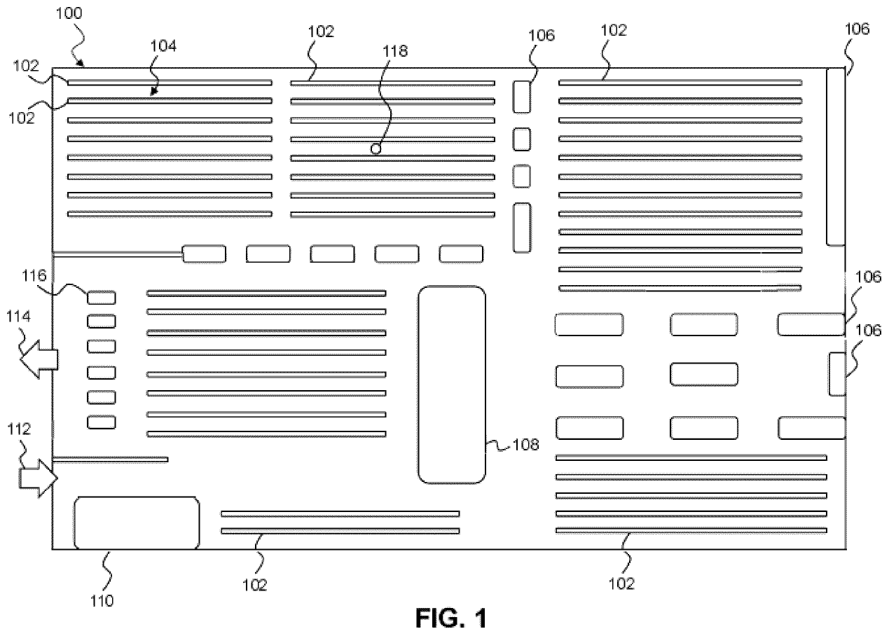

Referring to FIG. 1, one embodiment of an environment 100 illustrates a retail establishment, such as a store selling a variety of goods. The environment 100 is one example of many possible environments, and can be of any shape, size, configuration, and/or layout, including a configuration with multiple floors. In other embodiments, the environment can be an office building, a mall or shopping center, an indoor or outdoor entertainment venue (e.g., a stadium or arena), or any other building or area, whether indoors or outdoors, within which people can desire an order to be delivered while moving around within the building or area, i.e., moving around within the delivery envelope. Accordingly, it is understood that the environment 100 is intended to illustrate how the systems and methods of the present disclosure can be implemented and deployed and is not intended to be limiting.

The environment 100 can include multiple shelving units 102 that form aisles 104. Various shelving or display units 106, including endcaps, can be arranged within the environment in different ways. As is known, the actual arrangement and dimensions of shelves, the width and length of aisles, the location of endcaps, the division of the environment into various sections, and other configuration details can vary based on the requirements of the company controlling the environment 100, state and local ordinances, and similar factors. For example, and without limitation, sections within the environment 100 can form miniature stores or service areas, such as a pharmacy 108 and a coffee shop 110. Entry into the environment 100 can occur at one or more locations 112 and exit can occur at one or more locations 114 past checkout points 116 (e.g., cash registers and/or self-checkout islands).

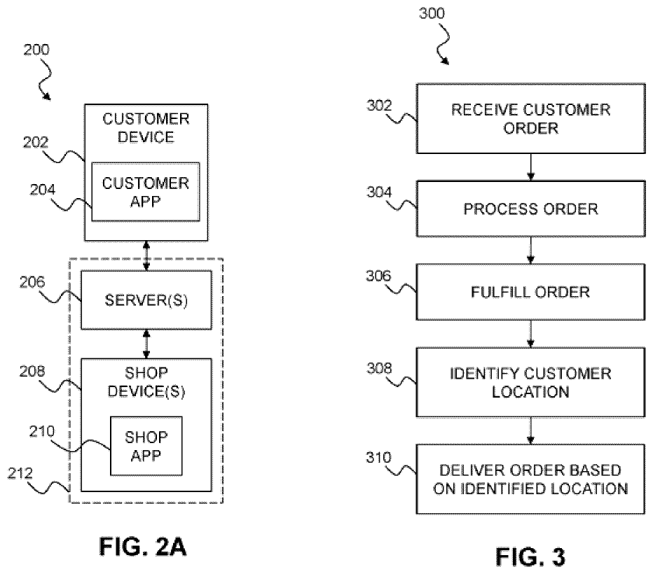

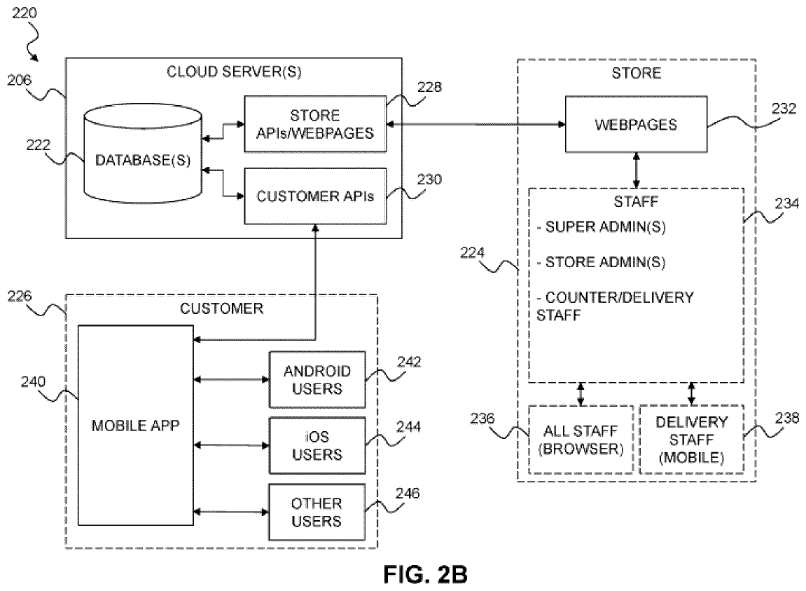

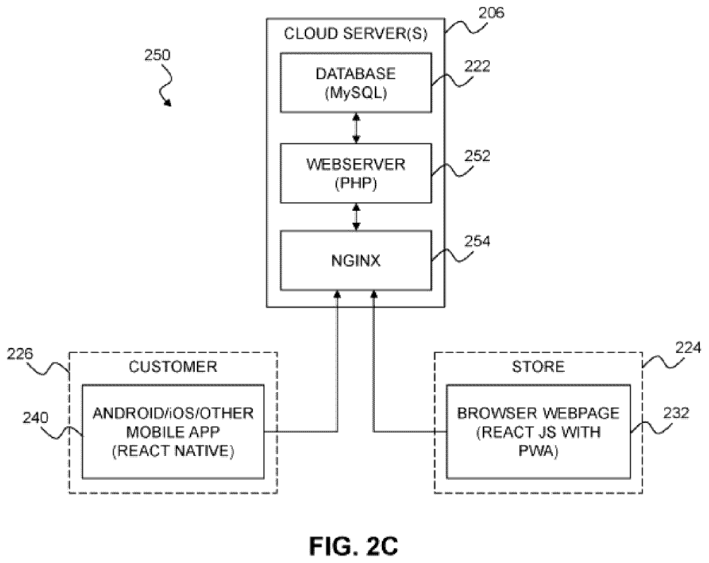

In the present example, a customer located at a customer location 118 has ordered coffee from the coffee shop 110 either by visiting the coffee shop directly or via an application (e.g., the customer application 204 of FIG. 2A). In the present disclosure, it is understood that the customer's location and the customer device's location are the same and the location can be referenced using either term. The coffee is to be delivered to the customer when ready while the customer continues shopping within the delivery envelope of the retail environment 100. Accordingly, the coffee shop personnel need to know the geolocation 118 of the customer within the environment 100.

Referring to FIG. 2A, one embodiment of an environment 200 is illustrated with a customer device 202 that contains a customer application 204. The customer application 204 communicates with one or more servers 206, which in turn communicates with one or more shop devices 208. The customer application 204 enables a user (e.g., the customer 118 of FIG. 1) of the device 202 to place an order. As will be described in greater detail below, the server 206 receives the order and sends information regarding the order to the shop device 208 for fulfilment. The order can then be delivered to the geolocation of the customer device 202 using a shop application 210 present on the shop device 208 for location mapping.

The server(s) 206 and shop device(s) 208, along with the applications 210, can form a system 212 that can be deployed for use in one or more shops (e.g., the coffee shop 110 of FIG. 1). For example, the servers 206 can be located in a server cloud and configured to provide services to multiple shops, with each shop having one or more shop devices 208 physically present at that shop's location. In this manner, the system 212 can be expanded as new shops are added, with the servers 206 being configured to interact with the new shop devices 208 as needed. The servers 206 can also be used to provide customer account management and other system-wide services, thereby enabling customers to be serviced regardless of the location of the shop used for fulfillment and delivery of a particular order.

The customer device 202 and shop devices 208 can be mobile devices (e.g., tablets, smartphones, personal digital assistants (PDAs), or netbooks), laptops, desktops, and/or any other computing device capable of receiving and sending electronic communications via a wired or wireless network connection. Such communications can be direct (e.g., via a peer-to-peer network, an ad hoc network, or using a direct connection), indirect, such as through a server or other proxy (e.g., in a client-server model), or can use a combination of direct and indirect communications.

The shop devices 208 can include mobile devices and/or devices coupled to a point of sale (POS) system. The POS system can be coupled to the shop's mobile devices directly or via the server 206. For example, the POS system can handle order processing and fulfillments, with the shop application 210 providing mobile access for order status, customer location, and similar information.

In other embodiments, rather than delivery occurring via delivery personnel, the delivery can be accomplished using an automated delivery system, such as a drone. In such cases, location information can be provided to software controlling the drone, thereby enabling the drone to identify and move to the location with the order. In such cases, the shop device 208 can be viewed as the drone.

Referring to FIG. 3, one embodiment of a method 300 is illustrated that can be executed within the environment 200 of FIG. 2A in order to provide order fulfillment and delivery within an environment such as the environment 100 of FIG. 1. In step 302, a customer order is received either by the server 206 or the shop device 208 depending on the particular implementation of the environment 200. In step 304, the order is processed. This processing can include account confirmation, billing, sending the order to a particular shop (e.g., if the order is received by a server 206 covering multiple shop locations), and similar actions. In step 306, the order is fulfilled. Continuing the example of a coffee shop, fulfillment can include preparing one or more drinks, retrieving pastries, and/or preparing other goods for delivery.

In step 308, the geolocation of the customer associated with the order is identified. In embodiments, it is understood that tracking can be ongoing following placement of the order, and the identified geolocation can be the current location when the order is ready for delivery. In other embodiments, the customer's geolocation can be obtained only when the order is ready for delivery. The identified geolocation can be identified by the server 206 or the shop device 208 depending on the particular implementation of the environment 200. In step 310, the order is delivered based on the identified geolocation.

Referring to FIG. 2B, one embodiment of an environment 220 illustrates a more detailed example of the environment 200 of FIG. 2A with information flow and control. In the present example, the server(s) 206 can be cloud servers that include one or more databases 222. The database 222 can be accessed by multiple stores 224 (e.g., using shop devices 208) and customers 226 (e.g., using customer devices 202). The functionality provided by the server 206 and database 222 can be accessed by the store 224 via store application programming interfaces (APIs) and/or webpages 228 (that can be accessed via a portal), and by the customer 226 via customer APIs 230.

The store 224 can provide webpages 232 to staff 234. The webpages 232 can be provided directly by the store 224 or via the store APIs/webpages 228. The webpages 232 can be customized for each store 224, with various management options and menu options provided for that store. Staff 234 can be organized in many different ways, but for purposes of example includes a super administrator (admin) account, store administrator accounts, and counter/delivery staff accounts.

In embodiments, there can be a single default super administrator account that has the power to add stores, products, and generally control overall management using the store APIs/webpages 228 accessed via the portal. The super administrator can create store administrator accounts for each store. A store administrator can have the power to create staff accounts (e.g., with an email format of staff@company.com) via the portal. In this aspect, store administrators can also be able to delete, suspend, and/or otherwise manage staff accounts at the same store. The super administrator can delete, suspend, and/or otherwise manage store administrator and staff accounts. Staff accounts can be able to enter, view, and/or otherwise manage orders.

In embodiments, it is contemplated that all staff can be able to access various webpages 232 via browsers 236 and delivery staff can access information via mobile applications 238 (e.g., shop applications 210). In embodiments, customers 226 can create and manage customer accounts via a mobile application 240 (e.g., the customer app 204) or a webpage (not shown) accessed via a browser. In optional aspects, customer account information can include names, billing information, email addresses, mobile numbers, order preferences, location information (e.g., tracking) authorizations, and/or similar information. The mobile application 240 can be different, or can have different implementations, for Android users 242, iOS users 244, and other types of devices/operating systems 246.

In embodiments, it is contemplated that the customer 226 can access a list of products with prices, descriptions, and similar information. The customer 226 can make selections, including quantity, and add the products to checkout. The checkout process can confirm delivery using live geo mapping and payment details. After ordering, the customer 226 can receive update notifications on the status of the order, such as accepted, processing, ready, delivered shortly, and delivered.

The staff 234 can see a list of ordered items that are queued. In operation, store staff can pick an order and start the fulfillment process, and then post to the delivery section once the order is ready. Delivery staff can pick up the delivery and deliver it to the customer using the determined geolocation information.

Referring to FIG. 2C, one embodiment of an environment 250 illustrates a more detailed example of the environment 220 of FIG. 2B with implementation details. It is understood that FIG. 2C illustrates one way in which the desired functionality can be implemented and is not intended to be limiting. In an exemplary embodiment, the cloud servers 206 can use a MySQL or other database 222 coupled to a webserver 252 (e.g., running a scripting language such as PHP). In this aspect, software 254 such as NGINX can be used to manage and control outward facing server connections, load balancing, and/or similar functions. In further exemplary aspects, the mobile application 240 used by the customer 226 can use a JavaScript library such as React Native and the browser webpages 232 can use the React JavaScript library with progressive web application (PWA) technology.

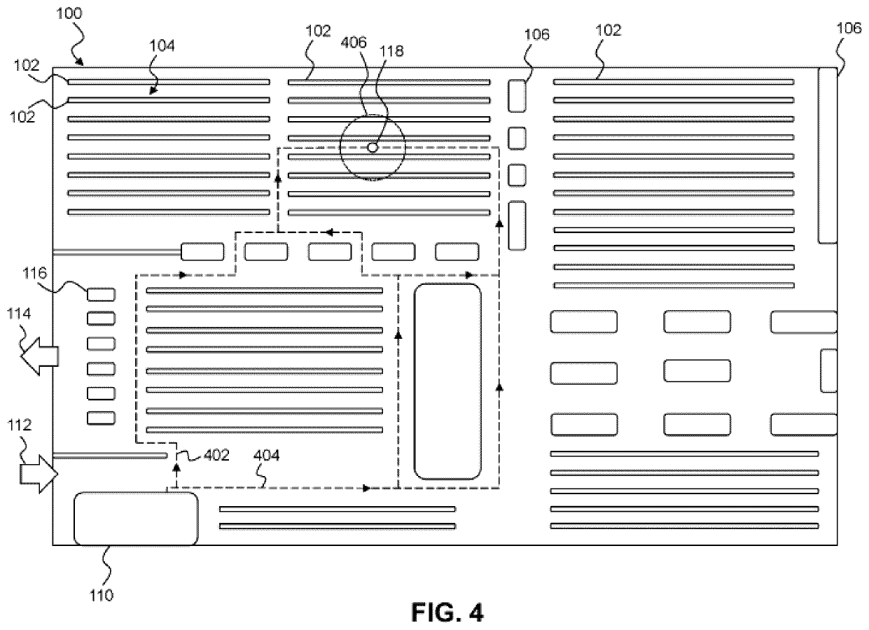

Referring to FIG. 4, another embodiment of the environment 100 of FIG. 1 is illustrated. For purposes of this example, an order for the customer is ready to be delivered. In order for the delivery to occur, the application 210 (FIG. 2A) needs to know the customer's geolocation 118 within the delivery envelope of the environment 100. Even if the customer's location is known, there can be multiple paths to reach the customer 118, as exemplified by initial paths 402 and 404. As shown, possible paths can split and/or merge prior to reaching the customer geolocation 118.

Accordingly, it is contemplated that the server 106 and/or shop devices 108 can calculate a path to the customer based on a number of factors. For example, the selected path can be chosen using a shortest route calculation (e.g., the fewest number of steps or the least distance). In another example, the simplest path (e.g., the path with the fewest turns) can be used. In more complicated embodiments, traffic patterns and other factors can be considered in the calculations. Traffic patterns can even be adjusted based on traffic fluctuations that occur over time, with different traffic patterns occurring on different days (e.g., Tuesdays can have different traffic patterns than Saturdays for a given time period).

In the example of FIG. 4, the initial path 402 can be less desirable than the initial path 404 because the path 402 passes near the checkout points 116, which can have heavier traffic and even lines that would slow down delivery and/or inconvenience customers. Accordingly, even if a certain path is shorter, it is contemplated that other factors can be taken into account when calculating the delivery route. As the floor plan for the environment 100 can be unique, each environment 100 can have a floor plan stored on the server 206 and/or shop devices 208 that allows delivery mapping to be calculated for that particular environment.

It is understood that the geolocation 118 may not be an exact location as shown by an estimated location circle 406, which is for purposes of illustration only and can be any size and/or shape. The accuracy of a particular customer's detected location can depend on many factors, such as the customer's privacy settings (and therefore the availability of beacons and/or other tracking information), the type of geolocation used, whether triangulation is available, the physical structure of the environment 100 (e.g., the thickness and material of the roof) that can affect signal propagation, multipath effects that can occur within the environment 100 around the customer and/or delivery personnel, and/or other factors. Accordingly, locations as used in the present disclosure can be highly precise or can be estimates based on the available information, and those estimates can vary in precision based on many different factors.

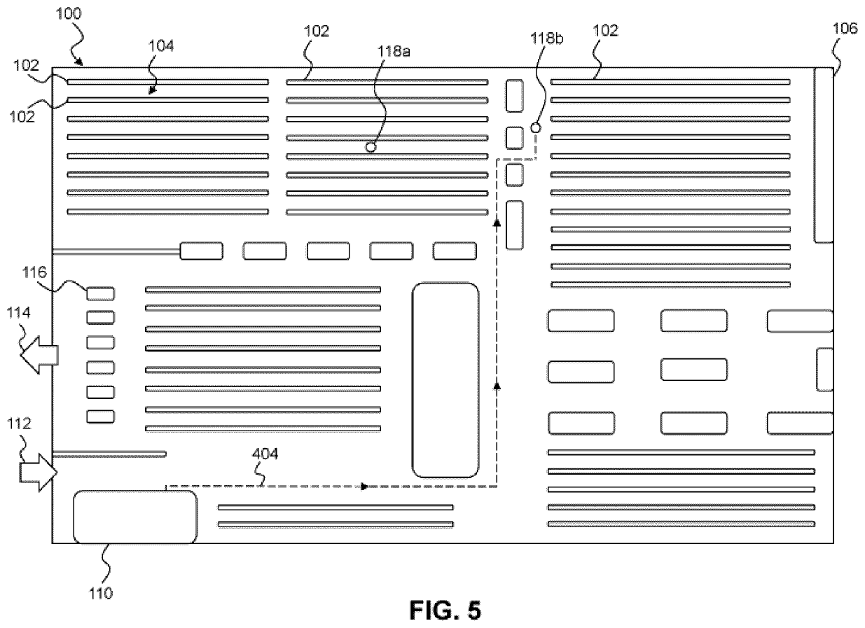

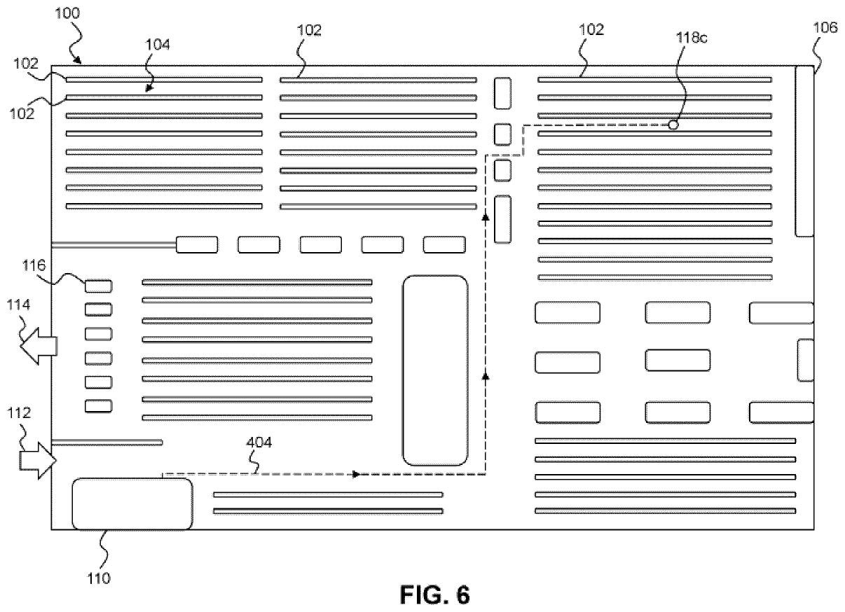

Referring to FIGS. 5 and 6, another embodiment of the environment 100 of FIG. 4 is illustrated. In the present example, the customer location 118a may not be stationary, but can move after the delivery has left the shop 110. Accordingly, in some implementations, the location 118a can be updated as the delivery is occurring. For example, the calculated path can change to deliver at a new customer location 118b (FIG. 5) and can further change to deliver at yet another customer location 118c (FIG. 6) as the customer passes through the delivery envelope of the environment 100. In this manner, the delivery location can intercept the customer even as the customer moves around and about the environment 100.

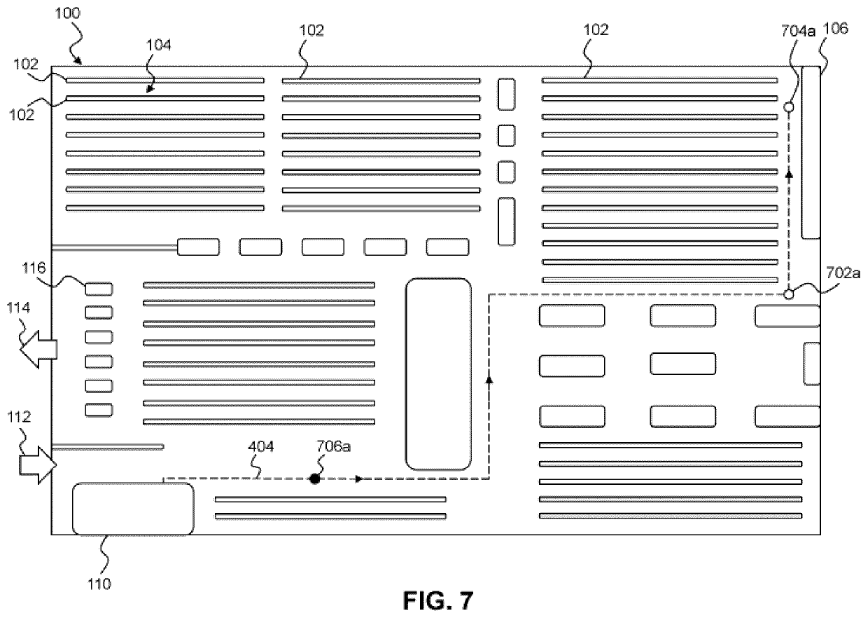

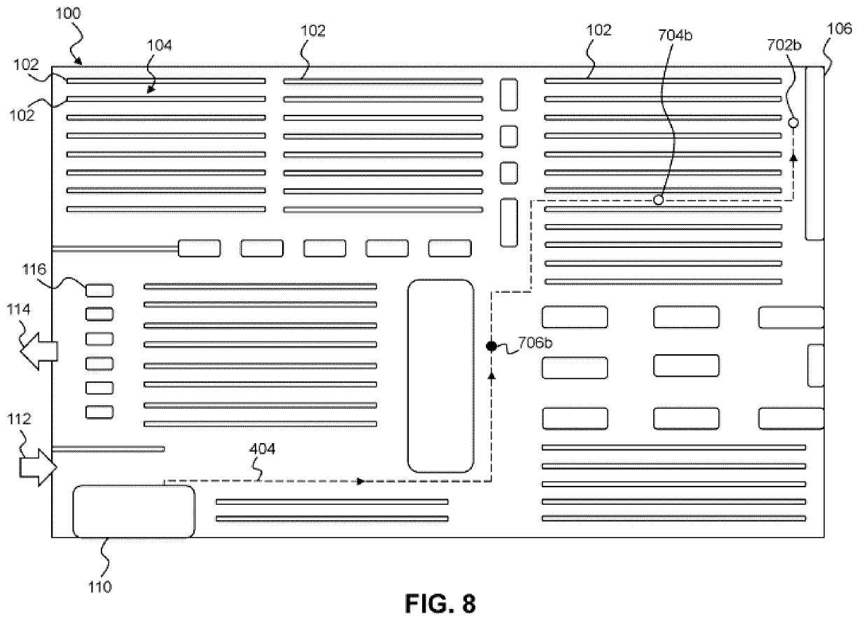

Referring to FIGS. 7 and 8, another embodiment of the environment 100 of FIG. 4 is illustrated. In the present example, the delivery priority can change if two customer locations switch in terms of nearness and/or other criteria while delivery to multiple customers is ongoing. For example, in FIG. 7, the original delivery path first schedules a delivery to a customer at customer location 702a, and then schedules a delivery to a customer at customer location 704a. This delivery plan is current when the delivery personnel from the shop 110 is at a location 706a. If the customers remain in the same approximate locations prior to delivery at customer location 702a, the delivery order can remain unchanged.

However, if the customer locations move significantly (e.g., relative to the original delivery plan), then the delivery order can be changed. This can be particularly useful in large environments having large delivery envelopes where the delivery person has to travel a greater distance, thereby giving customers more time to move from their initial locations. As shown in FIG. 8, the delivery person has reached a location 706b. The customer at customer location 702a has moved to a customer location 702b, and the customer at customer location 704a has moved to a customer location 704b. The new customer location 704b is now closer than the customer location 702a, causing the delivery path to be recalculated. The first delivery will now be to the customer at the customer location 704b and the second delivery will be to the customer at the customer location 702b.

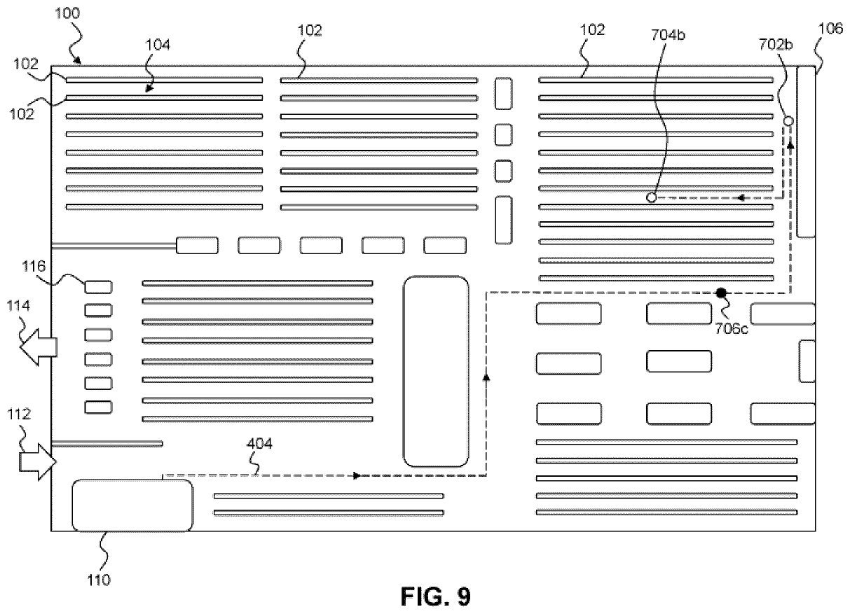

With additional reference to FIG. 9, it is understood that such reordering of deliveries may not occur if the delivery person is within a certain distance of a delivery location. For example, as shown in FIG. 9, if the delivery person is at location 706c when the path is recalculated, the delivery order can remain as originally planned. Accordingly, many different processes can be used to calculate delivery paths, and those paths can be changed dynamically based of various parameters and received location information.

If order parameters are considered when calculating paths, certain orders can take delivery priority over other orders. For example, if one customer has ordered a hot coffee and another customer has ordered a cold drink, the delivery path can be calculated to deliver the hot drink before the cold drink. Such parameters can include constraints that override the application of the parameters under certain conditions. For example, if the cold drink can be delivered on the same path before delivery of the hot drink, the hot drink's priority can be overridden. It is understood that in other embodiments, a delivery plan can be scheduled and not changed other than redirecting the delivery person as needed.

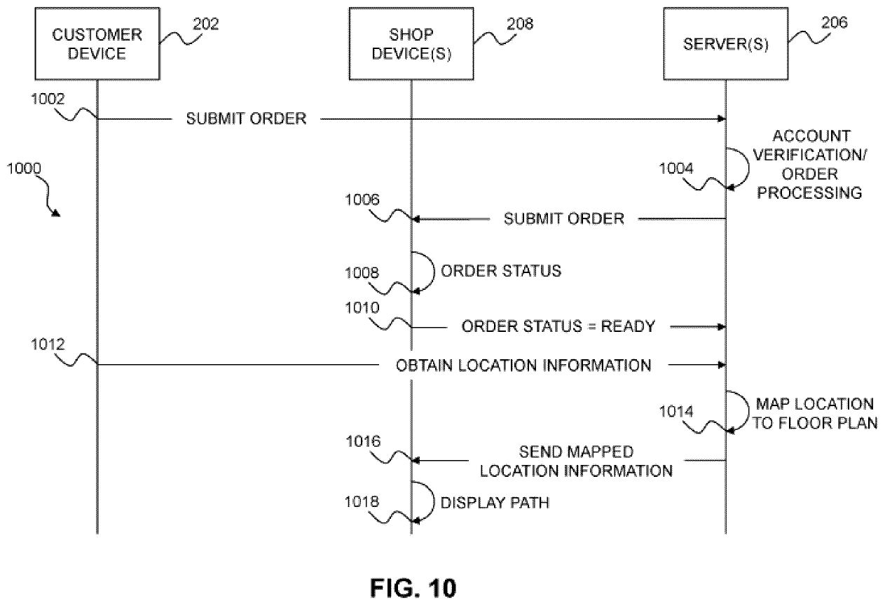

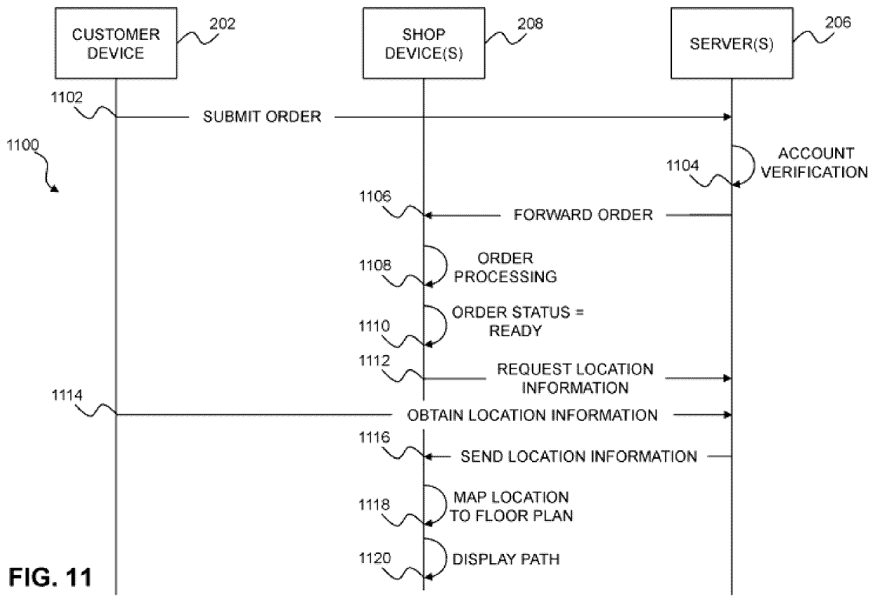

Referring to FIGS. 10 and 11, embodiments of sequence diagrams 1000 and 1100, respectively, illustrate various processes that can be executed within the environment 100 of FIG. 1 using the components of FIG. 2A. In order to provide the customer specific location information needed in environments such as that illustrated in FIG. 1, various messages can be passed between the customer device 202, server(s) 206, and/or shop device(s) 208. Although the examples of FIGS. 10 and 11 can contain details relevant specifically to the environment 100 of FIG. 1 (e.g., references to coffee shops, customers, and other retail oriented terminology), it is understood that the various steps can be applied to many different environments.

Referring specifically to FIG. 10, the sequence diagram 1000 illustrates an embodiment where the server 206 performs at least some of the delivery path processing. Accordingly, in step 1002, the customer device 202 uses the application 204 to place an order. The order can be placed either before or after the customer enters the environment 100.

In some embodiments, location information can be used to select the appropriate environment 100 (e.g., a particular store) for the order or the customer can need to select the store from a menu of possible locations. In still other embodiments, the customer's location can be used to estimate a time at which the customer will be available for delivery (e.g., if the customer is driving to the store after placing the order or is still in the parking lot). For example, the customer can place the order from home or another location before leaving for the store or can place the order on the way to the store.

It is understood that, using the application 204, the customer can place an order at their convenience in terms of time and/or location, and can schedule a desired fulfillment time when the customer expects to arrive at the store (e.g., immediately, in ten minutes, in one hour, or within a particular time frame). In some embodiments, the customer may not schedule a desired fulfillment time or such an option may not be presented to the customer, and location information can be used to schedule a time for order fulfillment, including preparation of the order, based on the customer's location.

In embodiments where the customer is able to place the order from a remote location (e.g., from home or elsewhere that is not on the premises of the store) and provide a desired fulfillment time, geolocation information can be used to determine whether to fulfill the order at the customer's desired time. Such geolocation information can override the customer's preferred fulfillment time. For example, if the customer sets a fulfillment time of one hour from order placement, geolocation information can be used to determine if the customer will reasonably be available for order pickup or delivery within the store as the fulfillment time approaches.

If, based on the geolocation information, the customer will not be available, the fulfillment time can be adjusted automatically or based on other input (e.g., from the store personnel). As one example, if the customer's desired fulfillment time is within the next ten minutes, but location information indicates that the customer is thirty minutes away based on such factors as distance and traffic conditions, the order can be held for fulfillment until the customer is within a certain time of arrival, such as ten or fifteen minutes. It is understood that the fulfillment time can be adjusted to ensure the order is ready when the customer arrives, and so can be scheduled prior to the customer's estimated time of arrival. In other embodiments, the customer can be notified to reschedule and/or otherwise adjust their desired fulfillment time.

In yet other embodiments, the customer may not be able to place an order unless the customer is within or near the environment 100 (e.g., in the parking lot). In such embodiments, a geofence and/or other location parameters can be used to identify the customer's location and whether they are eligible to place an order. In the present example, however, the customer simply places the order and the server 206 receives the order.

In step 1004, the server 206 processes the order, which can include account verification if such verification has not already been performed. For example, although not shown, the customer can have logged into the system via the application 204 before placing the order. In step 1006, the server 206 submits the order to the shop device(s) 208. For example, the order can go to a POS system within the shop 110. In step 1008, the order status can be monitored until, in step 1010, the shop device 208 notifies the server 206 that the order is ready.

In step 1012, the server 206 obtains current geolocation information of the customer device 202. In some embodiments, it is contemplated that this current geolocation information can be received regularly from the application 204. In step 1014, the server 206 maps the customer's geolocation to the floor plan of the environment 100. In step 1016, the server 206 sends the mapped location information to the shop devices 208.

The shop devices 208 can share this information internally in order to provide it to delivery devices. For example, a server or POS system that is one of the shop devices 208 can receive this information and forward it to a mobile device such as a tablet for display to a delivery person. In other embodiments, the mapped location information can be provided on the server 206 (e.g., as a web page) and accessed using a shop device 208. In step 1018, the shop device 208 displays the mapped location information so the delivery can be made to the customer's geolocation. Steps 1012 through 1018 can repeat to provide updated location as needed until the order is delivered.

Referring specifically to FIG. 11, the sequence diagram 1100 illustrates an embodiment is illustrated where the shop device(s) performs the delivery path processing. In step 1102, the customer device 202 uses the application 204 to place an order. In step 1104, the server 206 performs any needed account verification and, in step 1106, forwards the order to the shop device(s) 208. In step 1108, the order is processed by the POS system or another shop device 208. In step 1110, the order status can be monitored until the status indicates the order is ready.

In step 1112, the shop devices 208 can request location information corresponding to the order from the server 206. In step 1114, the server 206 receives current geolocation information of the customer device 202 and sends the geolocation information to the shop device 208 in step 1116. It is understood that, in some embodiments, this geolocation location information can be received regularly from the application 204 and forwarded to the shop device 208, making step 1112 unnecessary. In step 1118, the shop device 208 maps the customer's geolocation to the floor plan of the environment 100. In step 1120, the shop device 208 displays the mapped geolocation information so the delivery can be made to the customer's location. Steps 1112 through 1120 can repeat to provide updated location as needed until the order is delivered.

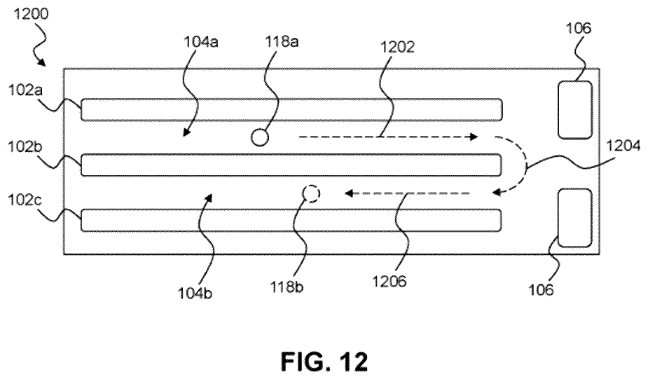

Referring to FIG. 12, one embodiment of a portion 1200 of the environment 100 of FIG. 1 is illustrated. In the present example, the customer at customer geolocation 118a may not be stationary but can be moving in the direction of arrow 1202. An estimated future delivery location 118b can be calculated based on factors such as the customer's movement patterns, typical movement patterns (e.g., generalized across some or all customers) for that area of the store, and/or other factors that enable a prediction that the customer will likely turn as indicated by arrow 1204 and then proceed towards the location 118b as indicated by arrow 1206.

For example, the customer's current path through the store and/or historical data on the customer's movement patterns within the store can be used to estimate the location 118b. In addition, the layout of the environment 100 can make certain movement patterns more likely. In some embodiments, dynamic pathing can be performed as described in other embodiments in addition to the use of estimated locations. Such dynamic pathing can account for changes in the estimated location due to unexpected movement patterns of the customer (e.g., taking a different route or altering movement speed).

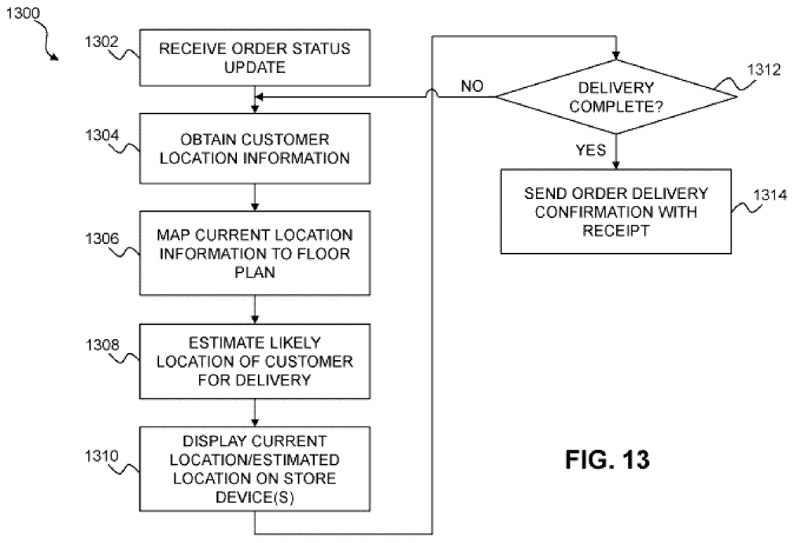

Referring to FIG. 13, one embodiment of a method 1300 is illustrated that can be executed within the environment 200 of FIG. 2A in order to provide order fulfillment and delivery within an environment such as the environment 1200 of FIG. 12. In step 1302, an order status update is received indicating, for example, that the order is ready for delivery. In step 1304, current customer geolocation information is obtained. In step 1306, the current geolocation is mapped to the floor plan. Using FIG. 12 as an example, the location 118a would be mapped.

In step 1308, an estimated geolocation (e.g., the location 118b of FIG. 12) is estimated and mapped to the floor plan. The current location and estimated geolocation can be displayed. In step 1312, if delivery is not complete, the method 1300 returns to step 1304 in order to update the current and/or estimated geolocations. If delivery is complete, the method 1300 moves from step 1312 to step 1314, where an order delivery confirmation can be sent with a receipt.

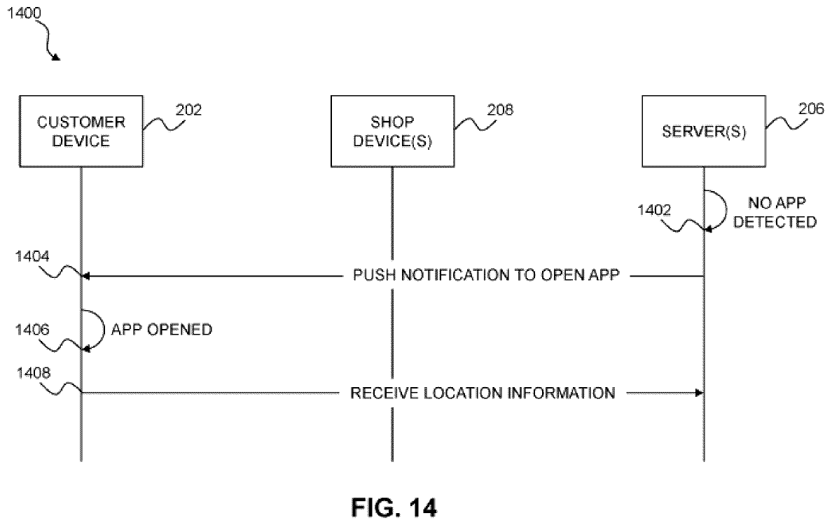

Referring to FIG. 14, one embodiment of a sequence diagram 1400 illustrates a process that can be executed within the environment 100 of FIG. 1 using the components of FIG. 2A. In order to obtain the customer specific geolocation information needed in environments such as that illustrated in FIG. 1, the application 204 can need to be open on the customer device 202. If the application 204 is not open, the server 206 may not be able to obtain geolocation information. For example, if the user of the device 202 has set the application to provide a location only when the application is open, closing the application will prevent the transmission of location information.

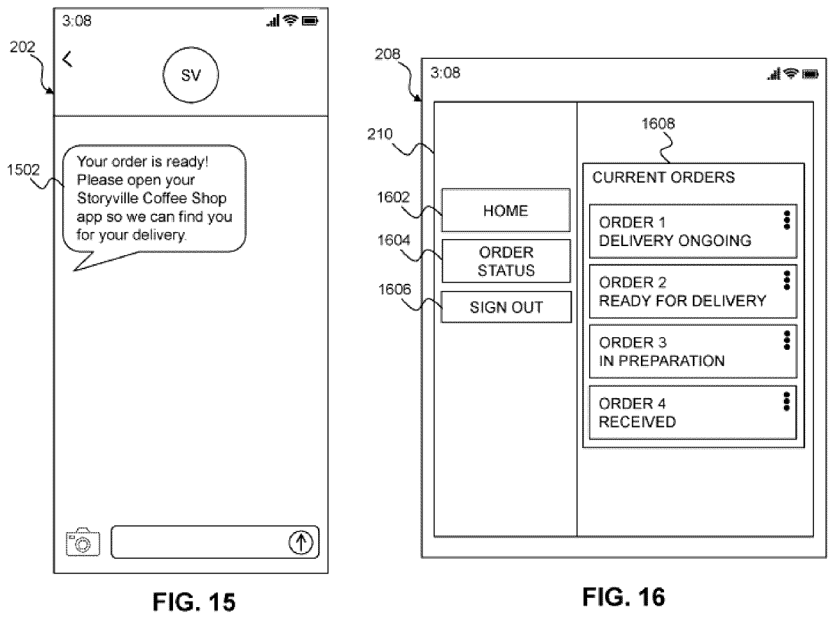

Accordingly, in step 1402, the server 206 can detect that the application 204 is not open on the customer device 202 after the customer has submitted an order. In step 1404, the server 206 can push a notification to the user device 202 requesting that the application 204 be opened. The notification can be a text message, an application notification, and/or other types of messages, including messages that provide a link to launch the application 204. Referring to FIG. 15, one embodiment of a mobile device screen is illustrated. In this exemplary, non-limiting, aspect, the mobile device can be the customer device 202, and a text message 2702 requesting that the application 204 be opened as described with respect to FIG. 14 is shown.

Referring to FIG. 16, one embodiment of a device screen is illustrated for a shop device 208, such as a tablet. The screen shows an example of the application 210, which in this embodiment can include a home button 1602, an order status button 1604, and a sign out button 1606. A current order section 1608 illustrates four orders with different statuses. Selecting an order from the current order section can bring up more detailed order information, including a delivery map for orders that are currently being delivered or are ready for delivery.

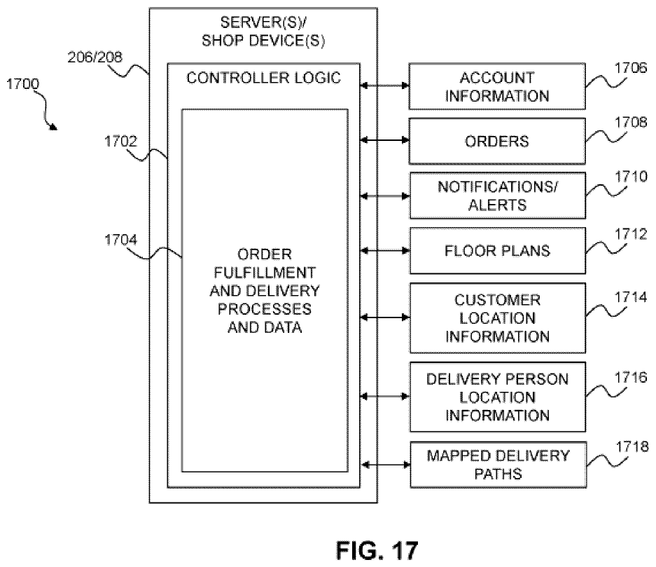

Referring to FIG. 17, one embodiment of a control structure 1700 is illustrated. Server(s) 206 and/or shop device(s) 208 can include controller logic 1702 that receives, sends, processes, stores, and/or executes various order fulfillment and delivery processes and data 1704. Various types of information can be used by and with the controller logic 1702, including account information 1706, order information 1708, notifications and alerts 1710, floor plans 1712, customer geolocation information 1714, delivery person location information 1716, and/or mapped delivery paths 1718. It is understood that more or fewer types of information can be used, and such information can be categorized, organized, and managed in many different ways.

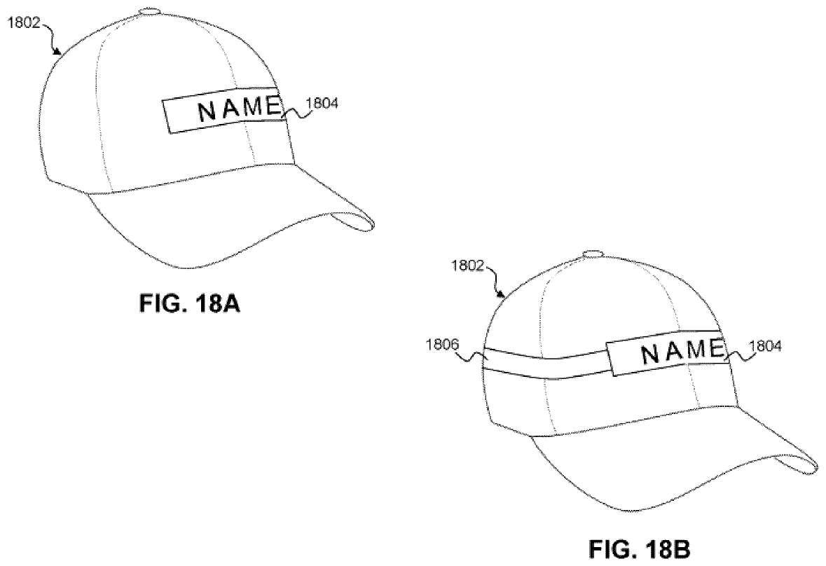

Referring to FIGS. 18A and 18B, embodiments of a wearable or holdable item 1802 are illustrated with a display module 1804. The item 1802 is shown as a baseball cap, but it is understood that the item can be any type of item that can be worn, carried, or moved by a delivery person, including hats, articles of clothing, armbands, signs, trays (including vending trays), cup holders, delivery carts, and/or any other suitable items. The display module 1804 can be built into, or affixed to, the item 1802 (e.g., glued, sown, and/or otherwise attached in a relatively permanent or irremovable manner) as shown in FIG. 18A, or can be intended for easy attachment and removal from the item 1802 (e.g., using Velcro, pockets, magnets, bands, pins, chains, straps, lanyards, and/or other attachment mechanisms) as shown with an elastic and/or adjustable band 1806 in FIG. 18B.

The display module 1804 can be configured to receive and display any desired information. In one exemplary aspect, the display module 1804 can be used to display the name of a customer. The display can change to indicate the current customer to which a delivery is being made. Such a display can provide various benefits, such as aiding customers in identifying the delivery person and/or identifying that it is their order that is being delivered. This can also simplify the delivery person's task, as the customer can be easier to identify if they are responding to their displayed name or order number.

The display can vary in size depending on the available space on the item and/or other factors. For example, a display attached to a cap can have less space than a display attached to a vendor tray or a cart. With larger displays, additional information can be shown, including more detailed order information (e.g., order number and name rather than one or the other) and/or multiple orders can be shown in their order of delivery or sorted using another criterion. Readability can also affect choices in display size and presentation parameters, such as the selection of a font size and/or color for text to be visible from a desired distance in the ambient light conditions. In some embodiments, an audio component can be available as an alternative to, or in addition to, the visual display. This can be particularly useful, for example, in alerting a customer with vision problems that their delivery is nearby.

If privacy concerns are an issue, the customer can select an alternate identifier to be displayed, either when placing the order or as a selectable option that is saved with their account information. This prevents the customer's actual name from being displayed while still enabling the customer to identify the delivery as theirs. In some examples, an order number can be displayed in addition to, or as an alternative to, a name. It is understood that any information can be displayed as long as the display is capable of showing the information. Accordingly, images, emotes, and/or other information can be used to identify customers and/or for other purposes.

In further embodiments, the display can show advertisements, websites, and/or other information when not displaying a customer name or can do so simultaneously with a name or other identifier. Such advertisements can be for the coffee shop or for other vendors and/or products. In some embodiments, the display can provide a code (e.g., QR code) that allows a person, such as a current or potential customer, to stop the delivery person and scan or otherwise capture the code. The code can enable the person to download the customer application 204, obtain or redeem a coupon for an order, access a webpage or other resources, and/or can be configured to perform any other functions that are accessible using such a code.

As described below, the display module 1804 can interact with one or more components in the environment 200 (FIG. 2A) in order to receive the information to be displayed (e.g., the customer's name) and then display the information. The display can change automatically (e.g., based on proximity or next delivery status) or can be manually changed (e.g., via the shop application 210).

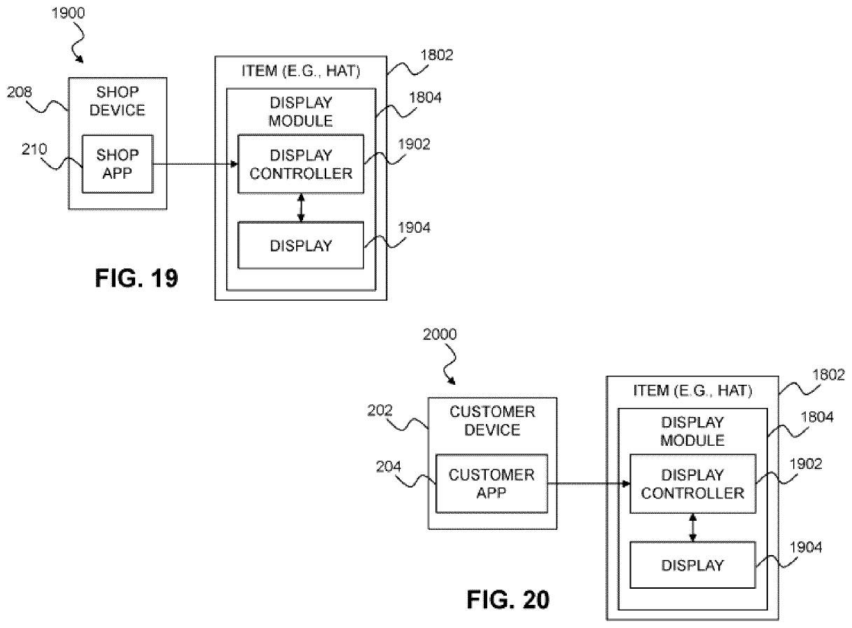

Referring to FIG. 19, one embodiment of an environment 1900 illustrates the display module 1804 coupled to the item 1802 (FIGS. 18A and 18B) interacting with a shop application 210 (FIG. 2A) present on a shop device 208. In the present example, the display module 1804 can include a display controller 1902 coupled to a display 1904. In this and other embodiments herein directed to a display, the display 1904 can be any type of visual display and can use any suitable type of display technology, including digital, analog, and/or combinations thereof. Examples of such technologies include liquid display crystal (LCD), light emitting diode (LED), including mini LED and micro LED, quantum dot LED (QLED), organic LED (OLED), and/or combinations thereof.

The display controller 1902 can be configured to receive display information from the shop app 210 and control the display 1904 to show the information in a visible form. The shop application 210/shop device 208 can communicate with the display controller 1902 in many different ways. For example, communications can use Bluetooth, wi-fi, and/or any other applicable communication formats, and can be hardwired in some embodiments.

Referring to FIG. 20, one embodiment of an environment 2000 illustrates the display module 1804 coupled to the item 1802 interacting with a customer app 204 (FIG. 2A) present on a customer device 202. This can be implemented as an alternative to, or in addition to, the interaction of the shop app 210 with the display module 1804 as shown in FIG. 19. Accordingly, in a manner similar to that of FIG. 19, the display controller 1902 can be configured to receive display information from the customer application 204 and control the display 1904 to show the information in a visible form.

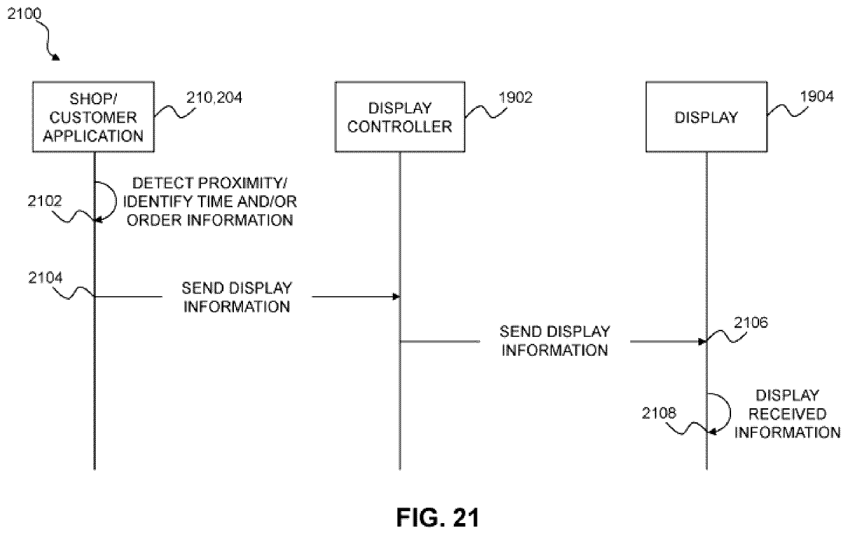

With additional reference to FIG. 21, one embodiment of a sequence diagram 2100 illustrates various processes that can be executed within the environment 100 of FIG. 1 using the components of FIGS. 19 and 20. In order to provide the display information needed in environments such as that illustrated in FIG. 1, information can be sent from the shop device 208 to the display module 1804 (as in FIG. 19) or from the customer device 202 to the display module 1804 (as in FIG. 20). Although the examples of FIG. 21 can contain details relevant specifically to the environment 100 of FIG. 1 (e.g., references to coffee shops, customers, and other retail oriented terminology), it is understood that the various steps can be applied to many different environments.

In step 2102, the shop application 210 on the shop device 208 determines that information is to be sent to the display controller 1902 of the display module 1804. The shop application 210 can make such a determination based on one or more factors, such as proximity detection of the customer device 202, a time (e.g., the delivery person should be making the next delivery within a certain time frame), a current order, and/or combinations thereof.

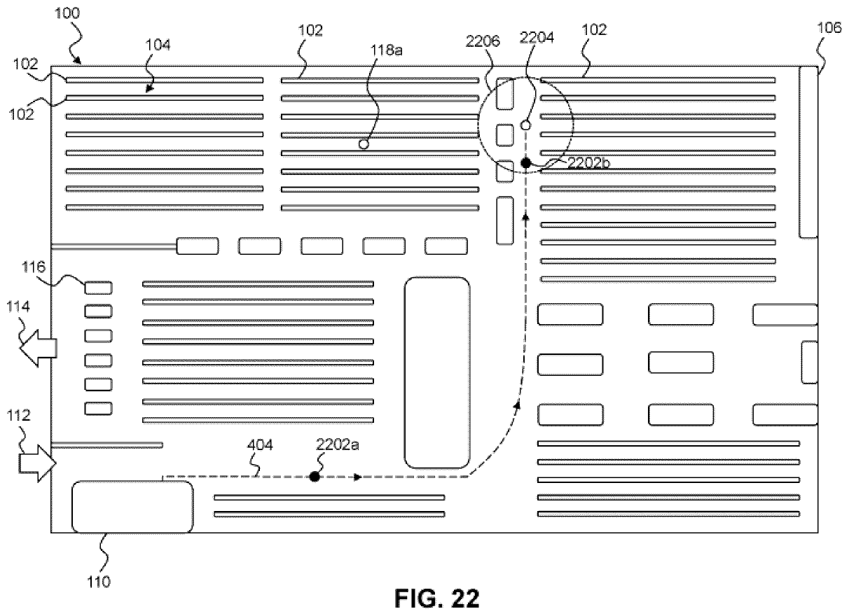

With additional reference to FIG. 22, one embodiment of the environment 100 of FIG. 4 is illustrated. In the present example, the delivery personnel from the shop 110 is positioned at a location 2202a and is moving towards the customer who is at a location 2204.

With respect to proximity (e.g., as referenced in step 2102 of FIG. 21), as the delivery personnel moves towards the customer, they arrive at a location 2202b that is on the edge of, or within, a proximity area 2206. The size and shape of the proximity area 2206 can be affected by many different factors, such as the mechanism used to determine proximity to the customer device 202, the strength of any signals (e.g., beacon signals), multipath effects that can occur within the environment 100 around the customer and/or delivery personnel, and/or other factors. Accordingly, it is understood that the actual distance between the delivery personnel and the customer at which a proximity trigger can be actuated can vary. The proximity distance can be defined in many ways and can be selected so that the display will show the order information for an estimated amount of time before a delivery (e.g., thirty seconds or one minute). Accordingly, the shop application 210 can detect that the shop device 208 has entered the proximity area, thereby identifying that it should initiate a change to the display 1904.

With respect to time, the shop application 210 can determine an estimated amount of time needed to move to the customer location 2204. Within a certain timeframe (e.g., one minute remaining until delivery), the shop application 210 can determine that it is to initiate an update to the display 1904.

With respect to an order, the shop application 210 can be configured to initiate an update of the display 1904 once an order is delivered and the next order is ready for delivery. It is understood that various display change triggers can be combined and/or used in a hierarchical manner. For example, the next order number can be displayed once the current order is delivered, and the proximity trigger can switch the order number to the customer's personal identifier (e.g., name).

Referring again to FIG. 21, because the shop application 210 is coupled to the server(s) 206 and/or other local shop devices, the shop application 210 has access to the information needed to correlate various account/order data and available real time information (e.g., proximity data) to both make the delivery and properly manage the display module 1804. Such information can be on the shop device 208 or can be obtained as needed from the server 206. For example, the shop application 210 can be aware of the customer's geolocation, the delivery personnel's location, the order information (e.g., customer's name or other identifier), display format, and/or other information that can be used to manage the display module 1804 to display the correct information in the desired manner.

In step 2104, the shop application 210 can send display information to the display controller 1902. The information can include any relevant instructions, including text and/or images to be displayed, animation/scroll timing (e.g., the movement speed if the text is to blink or scroll across the display 1904), text information (e.g., color, size, and/or font), an order in which various text/images are to be displayed, and/or similar information. It is understood that the display controller 1902 can be configured with default information so that received text/images are displayed using the default information unless other instructions are received that override the default information. For example, a default text size can be set in the display controller 1902, and the shop application 210 can be configured to send alternate text size information if desired that overrides the default text size.

In step 2106, the display controller 1902 can send display information to the display 1904. Depending on the implementation, the display controller 1902 can format and/or otherwise prepare the text/images and/or other information for display in a manner compatible with the display 1904. In step 2108, the display 1904 displays the information. In some embodiments, the customer application 204 can operate similarly to the shop application 210.

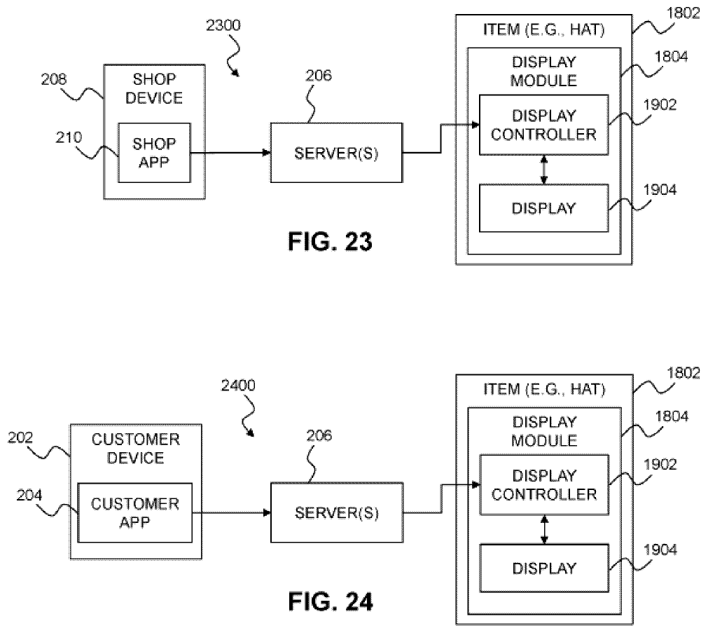

Referring to FIGS. 23 and 24, embodiments of environments 2300 and 2400, respectively, are similar to those of FIGS. 19 and 20 except that communications pass through server(s) 102 rather than directly between the control module 1804 and the shop application 210 (FIG. 23) and the customer application 204 (FIG. 24).

The server 206 has access to the information needed to correlate various account/order data with location information from the shop application 210/customer application 204 and available real time information (e.g., proximity data that can be received from the shop application 210/customer application 204) to properly manage the display module 1804. For example, the server 206 can be aware of the customer's location, the delivery personnel's location, the order information (e.g., customer's name or other identifier), display format, and/or other information that can be used to manage the display module 1804 to display the correct information in the desired manner.

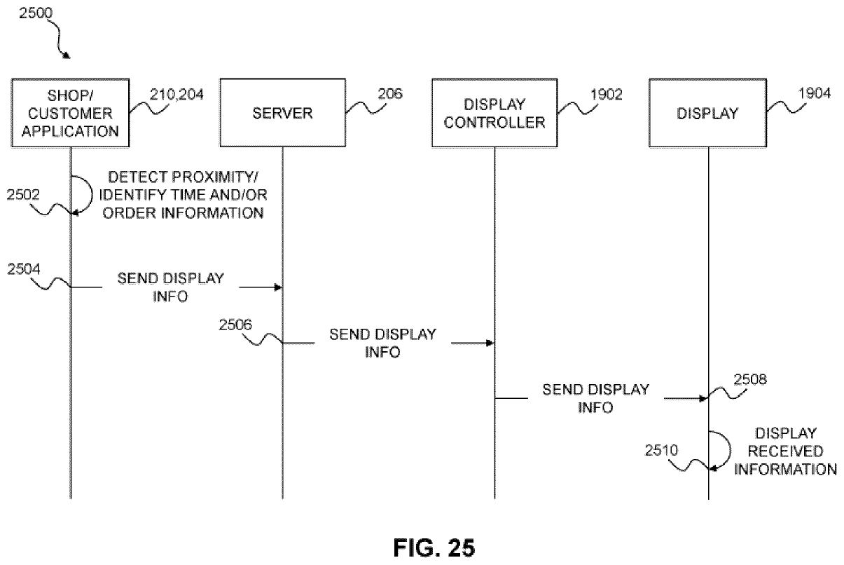

Referring to FIG. 25, one embodiment of a sequence diagram 2500, which is similar to the sequence diagram 2100 of FIG. 21, illustrates various processes that can be executed within the environment 100 of FIG. 1 using the components of FIGS. 23 and 24. Accordingly, in step 2502, the shop application 210/customer application 204 determines that information is to be sent to the display controller 1902 of the display module 1804. In step 2504, the display information is sent to the server 206, which sends the information to the display controller 1902 in step 2506. In step 2508, the display controller 1902 sends display information to the display 1904 and the display 1904 displays the information in step 2510.

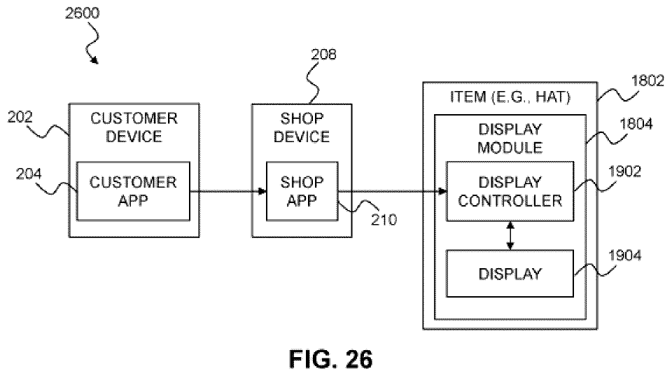

Referring to FIG. 26, one embodiment of an environment 2600 is similar to that of FIG. 24 except that communications pass through the shop device 208 rather than through the server 206. In this example, the shop application 210 can receive some or all of the needed information from the customer application 204 and interact with the display module 1804.

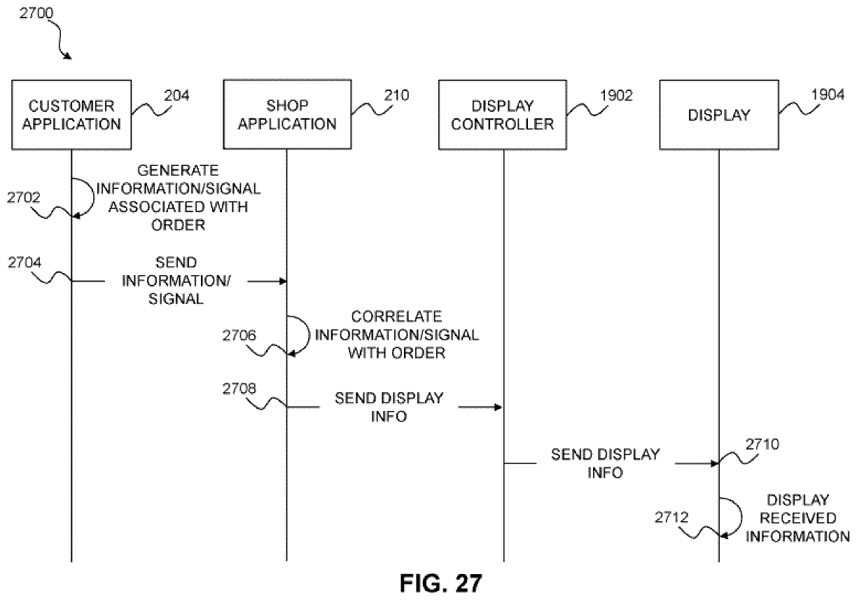

Referring to FIG. 27, one embodiment of a sequence diagram 2700, which is similar to the sequence diagram 2500 of FIG. 25, illustrates various processes that can be executed within the environment 100 of FIG. 1 using the components of FIG. 26. Accordingly, in step 2702, the customer application 204 can generate information and/or signals (e.g., a beacon signal) that is associated with an order. In step 2704, the information/signal can be sent. In step 2706, the shop application 210 can receive the information/signal and correlate the information/signal with a pending order. In step 2708, the display information is sent to the display controller 1902, which sends the information to the display 1904 in step 2710. In step 2712, the display 1904 displays the information.

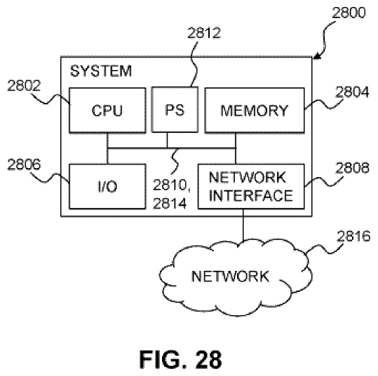

Referring to FIG. 28, one embodiment of a computer system 2800 is illustrated. The computer system 2800 is one possible example of a system component or computing device that can be used as part or all of the customer device 202, server 206, and/or shop device 208. The computer system 2800 can include a controller (e.g., a central processing unit (“CPU”)) 2802, a memory unit 2804, an input/output (“I/O”) device 2806, and a network interface 2808. The components 2802, 2804, 2806, and 2808 are interconnected by a transport system (e.g., a bus) 2810. A power supply (PS) 2812 can provide power to components of the computer system 2800, such as the CPU 2802 and memory unit 2804.

It is understood that the computer system 2800 can be differently configured and that each of the listed components can actually represent several different components. For example, the CPU 2802 can actually represent a multi-processor or a distributed processing system; the memory unit 2804 can include different levels of cache memory, main memory, hard disks, and remote storage locations; the I/O device 2806 can include monitors, keyboards, and the like; and the network interface 2808 can include one or more network cards providing one or more wired and/or wireless connections to a network 2816. Therefore, a wide range of flexibility is anticipated in the configuration of the computer system 2800.

The computer system 2800 can use any operating system (or multiple operating systems), including various versions of operating systems provided by Microsoft (such as WINDOWS), Apple (such as Mac OS X), UNIX, and LINUX, and can include operating systems specifically developed for handheld devices, personal computers, servers, and/or other specialized environments depending on the use of the computer system 2800. The operating system, as well as other instructions (e.g., for the processes described herein), can be stored in the memory unit 2804 and executed by the processor 2802. For example, if the computer system 2800 includes the controller logic 1702, the memory unit 2804 can include instructions for performing some or all of the processes and functionality associated with the controller logic as described in the present disclosure.

The network 2816 can be a single network or can represent multiple networks, including networks of different types. For example, components within the environment 200 can be coupled to a network that includes a cellular link coupled to a data packet network, or data packet link such as a wide local area network (WLAN) coupled to a data packet network. Accordingly, many different network types and configurations can be used to establish communications between components within the environment 200 and with other devices and systems.

Exemplary network, system, and connection types include the internet, WiMax, local area networks (LANs) (e.g., IEEE 802.11a and 802.11g wi-fi networks), digital audio broadcasting systems (e.g., HD Radio, T-DMB and ISDB-TSB), terrestrial digital television systems (e.g., DVB-T, DVB-H, T-DMB and ISDB-T), WiMax wireless metropolitan area networks (MANs) (e.g., IEEE 802.16 networks), Mobile Broadband Wireless Access (MBWA) networks (e.g., IEEE 802.20 networks), Ultra Mobile Broadband (UMB) systems, Flash-OFDM cellular systems, and Ultra-wideband (UWB) systems. Furthermore, the present disclosure can be used with communications systems such as Global System for Mobile communications (GSM) and/or code division multiple access (CDMA) communications systems. Connections to such networks can be wireless or can use a conduit (e.g., digital subscriber conduits (DSL), cable conduits, and fiber optic conduits).

Communication can be accomplished using predefined and publicly available (i.e., non-proprietary) communication standards or protocols (e.g., those defined by the Internet Engineering Task Force (IETF) or the International Telecommunications Union-Telecommunications Standard Sector (ITU-T)), and/or proprietary protocols. For example, signaling communications (e.g., session setup, management, and teardown) can use a protocol such as the Session Initiation Protocol (SIP), while data traffic can be communicated using a protocol such as the Real-time Transport Protocol (RTP), File Transfer Protocol (FTP), and/or Hyper-Text Transfer Protocol (HTTP). Communications can be connection-based (e.g., using a protocol such as the transmission control protocol/internet protocol (TCP/IP)) or connection-less (e.g., using a protocol such as the user datagram protocol (UDP)). It is understood that various types of communications can occur simultaneously.

It is understood that the flow charts and sequence diagrams described herein illustrate various exemplary functions and operations that can occur within various environments. It is understood that these embodiments are not exhaustive and that various steps can be excluded to clarify the aspect being described. For example, it is understood that some actions, such as network authentication processes and notifications, can have been performed prior to the first step of a flow chart or sequence diagram. Such actions can depend on the type and configuration of a particular device, including how network access is obtained (e.g., cellular or wi-fi access). Other actions can occur between illustrated steps or simultaneously with illustrated steps, including network messaging for call maintenance (including handoffs), communications with other devices (e.g., email, text messages, and/or voice calls (including conference calls)), and similar actions.

While the preceding description shows and describes one or more embodiments, it will be understood by those skilled in the art that various changes in form and detail can be made therein without departing from the spirit and scope of the present disclosure. For example, various steps illustrated within a particular sequence diagram or flow chart can be combined or further divided. In addition, steps described in one diagram or flow chart can be incorporated into another diagram or flow chart. Furthermore, the described functionality can be provided by hardware and/or software, and can be distributed or combined into a single platform. Additionally, functionality described in a particular example can be achieved in a manner different than that illustrated, but is still encompassed within the present disclosure. Therefore, the claims should be interpreted in a broad manner, consistent with the present disclosure.

What is claimed is:

1. A processor-based method for dynamically locating a moving customer for a delivery, comprising:
processing, on a server or a shop device, an order for one or more goods to be delivered;
identifying, using communication with a customer device having geolocation capability, a location of the customer, when the order is ready for the delivery; and
delivering the order, based on the so identified location.

2. The processor-based method for dynamically locating a moving customer for a delivery of claim 1, wherein:
the customer device having geolocation capability comprises a mobile communication device having a GPS (Global Positioning System) component and a first app to identify the location of the customer and communicate for the identifying; and
the server or shop device comprises a network-connectable computing device having a second app to process the order and to receive communication identifying the location of the customer from the customer device.

3. The processor-based method for dynamically locating a moving customer for a delivery of claim 1, further comprising:
establishing a geofence for order placing; and
identifying, using communication with the customer device having the geolocation capability, a location of the customer, when the customer attempts to place the order, wherein the processing the order is conditioned on the location of the customer for the order placing being within the geofence.

4. The processor-based method for dynamically locating a moving customer for a delivery of claim 1, further comprising:
mapping the so identified location of the customer to a floor plan of an environment; and
communicating the mapped location and floor plan to a mobile device for the delivery.

5. The processor-based method for dynamically locating a moving customer for a delivery of claim 4, further comprising updating location of the customer and so communicating with updated mapped location and floor plan to the mobile device for the delivery, until the order is delivered.

6. The processor-based method for dynamically locating a moving customer for a delivery of claim 1, further comprising performing, on the server or shop device, delivery path processing based on current location information of the customer device.

7. The processor-based method for dynamically locating a moving customer for a delivery of claim 6, further comprising updating the delivery path processing, until the order is delivered.

8. The processor-based method for dynamically locating a moving customer for a delivery of claim 1, further comprising estimating, on the server or shop device, a location of the customer for completion of the delivery, based on updating location of the customer, using the communication with the customer device having geolocation capability.

9. The processor-based method for dynamically locating a moving customer for a delivery of claim 1, further comprising
responsive to the processing the order, determining, on the server or shop device, whether a first app for the geolocation capability is active on the customer device; and
responsive to determining the first app for the geolocation capability is inactive on the customer device, pushing a notification to the customer device to activate the first app.

10. The processor-based method for dynamically locating a moving customer for a delivery of claim 1, further comprising scheduling, on the server or shop device, a fulfillment time for the order based on updated location of the customer, using the communication with the customer device having geolocation capability.

11. A system for dynamically locating a moving customer for a delivery, comprising:
a server or a shop device, having network connectivity and a processor; and the processor of the server or shop device to perform:
processing an order for one or more goods to be delivered;
communicating with a customer device having geolocation capability;
identifying, using communication with the customer device, a location of the customer, when the order is ready for the delivery; and
indicating for the delivery, the so identified location.

12. The system for dynamically locating a moving customer for a delivery of claim 11, wherein
the customer device having geolocation capability comprises a mobile communication device having a GPS (Global Positioning System) component and a first app to identify the location of the customer and communicate for the identifying; and
the server or shop device comprises a network-connectable computing device having a second app to process the order and to receive communication identifying the location of the customer from the customer device.

13. The system for dynamically locating a moving customer for a delivery of claim 11, further comprising:
an item with a display module;
the display module to receive and display, from the server or shop device, information relating to the delivery.

14. The system for dynamically locating a moving customer for a delivery of claim 13, further comprising:
the server or shop device to determine a proximity of the shop device and the customer device; and
the server or shop device to communicate to the display module a change to display based on an estimated time before delivery, or the determined proximity.

15. A tangible, non-transitory, computer-readable media having instructions thereupon which, when executed by a processor, cause the processor to perform a method comprising:
processing, on a server or a shop device, an order for one or more goods to be delivered;
identifying, using communication with a customer device having geolocation capability, a location of the customer, when the order is ready for the delivery; and
indicating the so identified location of the customer for delivering the order.

16. The tangible, non-transitory, computer-readable media having instructions thereupon of claim 15, comprising:
a first app installable on a mobile communication device having a GPS (Global Positioning System) component as the customer device having geolocation capability, to identify the location of the customer and communicate for the identifying.

17. The tangible, non-transitory, computer-readable media having instructions thereupon of claim 15, comprising:
a second app installable on the server or shop device, which comprises a network-connectable computing device, to process the order and to receive communication identifying the location of the customer from the customer device.

18. The tangible, non-transitory, computer-readable media having instructions thereupon of claim 15, wherein the method further comprises:
mapping the so identified location of the customer to a floor plan of an environment;
communicating the mapped location and floor plan to a mobile device for the delivery; and
updating location of the customer and so communicating with updated mapped location and floor plan to the mobile device for the delivery, until the order is delivered.

19. The tangible, non-transitory, computer-readable media having instructions thereupon of claim 15, wherein the method further comprises:
performing, on the server or shop device, delivery path processing based on current location information of the customer device; and
updating the delivery path processing, until the order is delivered.

20. The tangible, non-transitory, computer-readable media having instructions thereupon of claim 15, wherein the method further comprises:
estimating, on the server or shop device, a location of the customer for completion of the delivery, based on updating location of the customer, using the communication with the customer device having geolocation capability.
